(19) United States
(12) Patent Application Publication
(10) Pub. No.: US 2020/0296336 A1
(43) Pub. Date: Sep. 17, 2020

(54) IMAGING SYSTEMS AND METHODS FOR GENERATING COLOR INFORMATION AND PULSED LIGHT INFORMATION

(71) Applicant: SEMICONDUCTOR COMPONENTS INDUSTRIES, LLC, Phoenix, AZ (US)

(72) Inventor: Yoshihito HIGASHITSUTSUMI, Koto-ku (JP)

(73) Assignee: SEMICONDUCTOR COMPONENTS INDUSTRIES, LLC, Phoenix, AZ (US)

(21) Appl. No.: 16/713,654

(22) Filed: Dec. 13, 2019

Related U.S. Application Data
(60) Provisional application No. 62/819,081, filed on Mar. 15, 2019.

(51) Int. Cl. H04N 9/04; H04N 5/33

(52) U.S. Cl. CPC H04N 9/0451; H04N 9/0455; H04N 5/33

(57) ABSTRACT

An imaging system may include a light source configured to irradiate an environment with non-color (IR) light. An image sensor in the imaging system may include pixels that are sensitive to the non-color light and color light. In particular, a light filter system may be formed over the pixels that pass the non-color light and the color light. Control circuitry may be configured to control the light source to pulse the non-color light during a global shutter operation of the image sensor. Control circuitry may also be configured to control the light source not to pulse during a rolling shutter operation of the image sensor. The image sensor may be configured to generate image signals for the global shutter operation and the rolling shutter operation. Readout circuitry may be configured to extract color information and non-color pulsed light information from the generated image signals.

### BACKGROUND

This relates generally to imaging devices, and more particularly, to imaging devices for generating color information as well as pulsed light information.

Image sensors are commonly used in electronic devices such as cellular telephones, cameras, and computers to capture images. In a typical arrangement, an image sensor includes an array of image pixels arranged in pixel rows and pixel columns. Circuitry may be coupled to each pixel column for reading out image signals from the image pixels.

Typical image pixels contain a photodiode for generating charge in response to incident light. Image pixels may also include a charge storage region for storing charge that is generated in the photodiode. Image sensors can operate using a global shutter or a rolling shutter scheme. In a global shutter, every pixel in the image sensor may simultaneously capture image signals, whereas in a rolling shutter each row of pixels may sequentially capture image signals.

In general, the image sensor can use one of these two operating schemes to generate a color image. However, some applications require capturing other image information in addition to generating a color image. While separate imaging systems can capture separate frames that convey the other image information separately from frames that generate the color image, this is inefficient, and will necessitate the use of large amounts of resource (e.g., memory, area, etc.) when trying to generate the other image information and the color image.

It would therefore be desirable to be able to provide imaging systems with improved data generating capabilities.

### BRIEF DESCRIPTION OF THE DRAWINGS

FIG. 1 is a diagram of an illustrative electronic device having an image sensor and processing circuitry for capturing images using an array of image pixels in accordance with some embodiments.

FIG. 2 is a diagram of an illustrative pixel array and associated readout circuitry for reading out image signals from the pixel array in accordance with some embodiments.

FIG. 3 is a circuit diagram of an illustrative image pixel having a capacitor coupled to a floating diffusion region in accordance with some embodiments.

FIG. 4 is a block diagram of an illustrative imaging system configured to generate pulsed light information and color information from image frames in accordance with some embodiments.

FIG. 5 is a graph showing transmission characteristics of a filter in an imaging system such as the illustrative imaging system shown in FIG. 4 in accordance with some embodiments.

FIG. 6 is a block diagram showing illustrative image pixels that are sensitive to different wavelengths of light in accordance with some embodiments.

FIG. 7 is a timing diagram for operating an imaging system such as the illustrative imaging system shown in FIG. 4 having pixels such as the illustrative image pixel shown in FIG. 3 to generate pulsed light information and color information in accordance with some embodiments.

FIG. 8 is a block diagram showing illustrative readout circuitry configured to extract pulsed light information and color information from image frames in accordance with some embodiments.

### DETAILED DESCRIPTION

Electronic devices such as digital cameras, computers, cellular telephones, and other electronic devices may include image sensors that gather incoming light to capture an image. The image sensors may include arrays of image pixels. The pixels in the image sensors may include photosensitive elements such as photodiodes that convert the incoming light into image signals. Image sensors may have any number of pixels (e.g., hundreds or thousands or more). A typical image sensor may, for example, have hundreds of thousands or millions of pixels (e.g., megapixels). Image sensors may include control circuitry such as circuitry for operating the image pixels and readout circuitry for reading out image signals corresponding to the electric charge generated by the photosensitive elements.

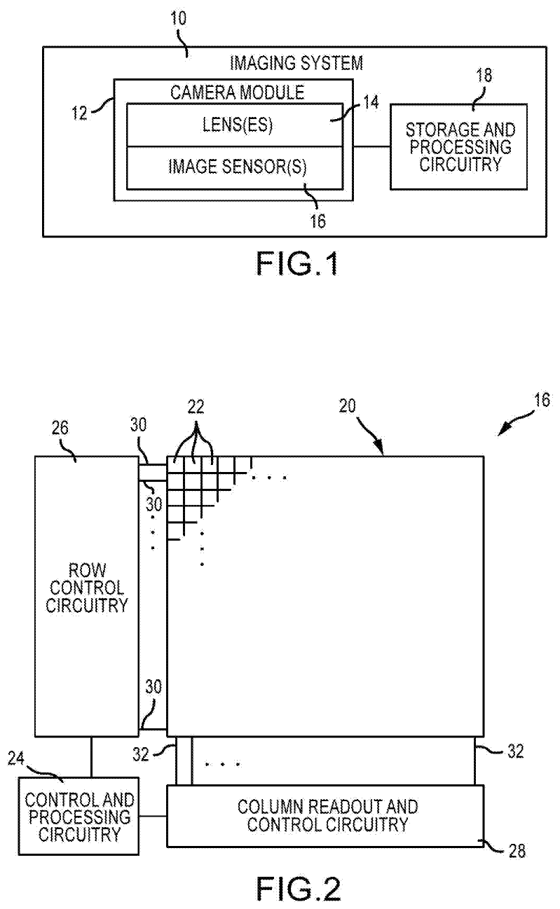

FIG. 1 is a diagram of an illustrative imaging system such as an electronic device that uses an image sensor to capture images. Electronic device 10 of FIG. 1 may be a portable electronic device such as a camera, a cellular telephone, a tablet computer, a webcam, a video camera, a video surveillance system, an automotive imaging system, a video gaming system with imaging capabilities, or any other desired imaging system or device that captures digital image data. Camera module 12 (sometimes referred to as an imaging module) may be used to convert incoming light into digital image data. Camera module 12 may include one or more lenses 14 and one or more corresponding image sensors 16. Lenses 14 may include fixed and/or adjustable lenses and may include microlenses formed on an imaging surface of image sensor 16 and other macro lenses. During image capture operations, light from a scene may be focused onto image sensor 16 by lenses 14. Image sensor 16 may include circuitry for converting analog pixel image signals into corresponding digital image data to be provided to storage and processing circuitry 18. If desired, camera module 12 may be provided with an array of lenses 14 and an array of corresponding image sensors 16.

Storage and processing circuitry 18 may include one or more integrated circuits (e.g., image processing circuits, microprocessors, storage devices such as random-access memory and non-volatile memory, etc.) and may be implemented using components that are separate from the camera module and/or that form part of the camera module (e.g., circuits that form part of an integrated circuit that includes image sensors 16 or an integrated circuit within the module that is associated with image sensors 16). When storage and processing circuitry 18 is included on different integrated circuits (e.g., chips) than those of image sensors 16, the integrated circuits with circuitry 18 may be vertically stacked or packaged with respect to the integrated circuits with image sensors 16. Image data that has been captured by the camera module may be processed and stored using processing circuitry 18 (e.g., using an image processing engine on processing circuitry 18, using an imaging mode selection engine on processing circuitry 18, etc.). Processed image data may, if desired, be provided to external equipment (e.g., a computer, external display, or other device) using wired and/or wireless communications paths coupled to processing circuitry 18.

As shown in FIG. 2, image sensor 16 may include a pixel array 20 containing image sensor pixels 22 arranged in rows and columns (sometimes referred to herein as image pixels or pixels) and control and processing circuitry 24. Array 20 may contain, for example, hundreds or thousands of rows and columns of image sensor pixels 22. Control circuitry 24 may be coupled to row control circuitry 26 and image readout circuitry 28 (sometimes referred to as column control circuitry, readout circuitry, processing circuitry, or column decoder circuitry). Row control circuitry 26 may receive row addresses from control circuitry 24 and supply corresponding row control signals such as reset, row-select, charge transfer, dual conversion gain, and readout control signals to pixels 22 over row control paths 30. One or more conductive lines such as column lines 32 may be coupled to each column of pixels 22 in array 20. Column lines 32 may be used for reading out image signals from pixels 22 and for supplying bias signals (e.g., bias currents or bias voltages) to pixels 22. If desired, during pixel readout operations, a pixel row in array 20 may be selected using row control circuitry 26 and image signals generated by image pixels 22 in that pixel row can be read out along column lines 32.

Image readout circuitry 28 may receive image signals (e.g., analog pixel values generated by pixels 22) over column lines 32. Image readout circuitry 28 may include sample-and-hold circuitry for sampling and temporarily storing image signals read out from array 20, amplifier circuitry or a multiplier circuit, analog to digital conversion (ADC) circuitry, bias circuitry, column memory, latch circuitry for selectively enabling or disabling the column circuitry, or other circuitry that is coupled to one or more columns of pixels in array 20 for operating pixels 22 and for reading out image signals from pixels 22. ADC circuitry in readout circuitry 28 may convert analog pixel values received from array 20 into corresponding digital pixel values (sometimes referred to as digital image data or digital pixel data). Image readout circuitry 28 may supply digital pixel data to control and processing circuitry 24 and/or processor 18 (FIG. 1) for pixels in one or more pixel columns.

If desired, image pixels 22 may include more than one photosensitive region for generating charge in response to image light. Photosensitive regions within image pixels 22 may be arranged in rows and columns on array 20. Pixel array 20 may be provided with a filter array having multiple (color) filter elements (each corresponding to a respective pixel) which allows a single image sensor to sample light of different colors or sets of wavelengths. As an example, image sensor pixels such as the image pixels in array 20 may be provided with a color filter array having red, green, and blue filter elements, which allows a single image sensor to sample red, green, and blue (RGB) light using corresponding red, green, and blue image sensor pixels arranged in a Bayer mosaic pattern.

The Bayer mosaic pattern consists of a repeating unit cell of two-by-two image pixels, with two green image pixels (under filter elements that pass green light) diagonally opposite one another and adjacent to a red image pixel (under a filter element that passes red light) diagonally opposite to a blue image pixel (under a filter element that passes blue light). In another suitable example, the green pixels in a Bayer pattern may be replaced by broadband image pixels having broadband color filter elements (e.g., clear color filter elements, yellow color filter elements, etc.). In yet another example, one of the green pixels in a Bayer pattern may be replaced by infrared (IR) image pixels formed under IR color filter elements and/or the remaining red, green, and blue image pixels may also be sensitive to IR light (e.g., may be formed under filter elements that pass IR light in addition to light of their respective colors). These examples are merely illustrative and, in general, filter elements of any desired color and/or wavelength and in any desired pattern may be formed over any desired number of image pixels 22.

Additionally, separate microlenses may be formed over each image pixel 22 (e.g., with light or color filter elements interposed between the microlenses and image pixels 22). The microlenses may form an array of microlenses that overlap the array of light filter elements and the array of image sensor pixels 22. Each microlens may focus light from an imaging system lens onto a corresponding image pixel 22, or multiple image pixels 22 if desired.

Image sensor 16 may include one or more arrays 20 of image pixels 22. Image pixels 22 may be formed in a semiconductor substrate using complementary metal-oxide-semiconductor (CMOS) technology or charge-coupled device (CCD) technology or any other suitable photosensitive devices technology. Image pixels 22 may be frontside illumination (FSI) image pixels or backside illumination (BSI) image pixels. If desired, image sensor 16 may include an integrated circuit package or other structure in which multiple integrated circuit substrate layers or chips are vertically stacked with respect to each other. In this scenario, one or more of circuitry 24, 26, and 28 may be vertically stacked above or below array 20 within image sensor 16. If desired, lines 32 and 30 may be formed from vertical conductive via structures (e.g., through-silicon vias or TSVs) and/or horizontal interconnect lines in this scenario.

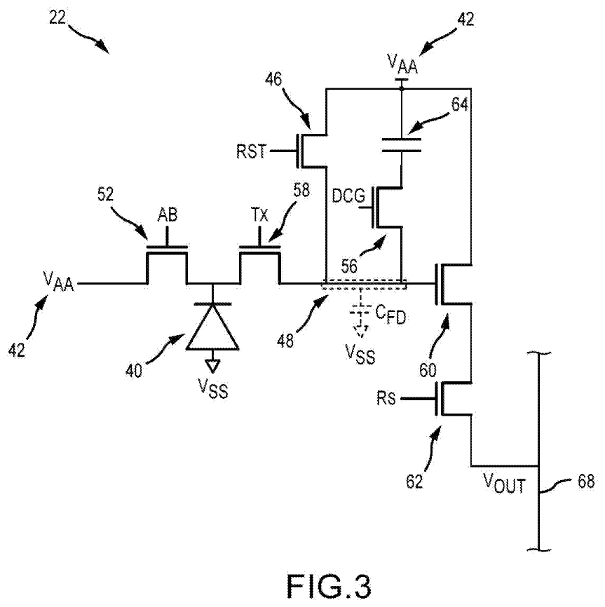

FIG. 3 is a circuit diagram of an illustrative image pixel 22. As shown in FIG. 3, pixel 22 may include a photosensitive element such as photodiode 40. A positive power supply voltage V_{AA} may be supplied at positive power supply terminals 42. Incoming light may be collected by photodiode 40. In certain embodiments, a light filter structure may be included and incoming light may pass through the light filter structure before being collected in photodiode 40. In such a way, photodiode 40 may be sensitive to only light that passes the light filter structure. Photodiode 40 may generate charge (e.g., electrons) in response to receiving impinging photons. The amount of charge that is collected by photodiode 40 depends on the intensity of the impinging light and the exposure duration (or integration time).

Before an image is acquired, reset transistor 46 may be turned on to reset charge storage region 48 (sometimes referred to as a floating diffusion region) to voltage V_{AA}. The voltage levels stored at floating diffusion region 48 may be read out using charge readout circuitry. The charge readout circuitry may include source follower transistor 60 and row select transistor 62. The signal stored at charge storage region 48 may include a reset level signal and/or an image level signal.

Pixel 22 may include a photodiode reset transistor such as reset transistor 52 (sometimes referred to as anti-blooming transistor). When reset transistor 52 is turned on, photodiode 40 may be reset to power supply voltage V_{AA} (e.g., by connecting voltage V_{AA} to photodiode 40 through reset transistor 52). When reset transistor 52 is turned off, photodiode 40 may begin to accumulate photo-generated charge.

Pixel 22 may include a transfer transistor 58. Transfer transistor 58 may be turned on to transfer charge from photodiode 40 to floating diffusion region 48. Floating diffusion region 48 may be a doped semiconductor region (e.g., a region in a silicon substrate that is doped by ion implantation, impurity diffusion, or other doping process). Floating diffusion region 48 may have an associated charge storage capacity (e.g., as indicated by capacitance CFD).

Row select transistor 62 may have a gate terminal that is controlled by a row select signal (i.e., signal RS). When the row select signal is asserted, transistor 62 is turned on and a corresponding signal V_{OUT} (e.g. an output signal having a magnitude that is proportional to the amount of charge at floating diffusion node 48), is passed onto a pixel output path and column line 68 (i.e., line 32 in FIG. 2).

In a typical image pixel array configuration, there are numerous rows and columns of pixels 22. A column readout path may be associated with each column of pixels 22 (e.g., each image pixel 22 in a column may be coupled to the column readout path through an associated row-select transistor 62). The row select signal may be asserted to read out signal V_{OUT} from a selected image pixel onto the pixel readout path. Image data V_{OUT} may be fed to readout circuitry 28 and processing circuitry 18 for further processing.

Pixel 22 may also include dual conversion gain transistor 56 and charge storage structure 64 (e.g., capacitor 64). Transistor 56 may couple charge storage structure 64 to floating diffusion region 48. Capacitor 64 may be interposed between transistor 56 and positive voltage supply 42 such as a voltage supply rail. In other words, capacitor 64 may have a first terminal coupled to voltage supply 42 and a second terminal coupled to transistor 56. As such, capacitor 64 may extend the storage capacity of floating diffusion region 48 in storing image charge (e.g., by activating transistor 56, when charge stored at floating diffusion region 48 is above a potential barrier and overflows to capacitor 64, etc.). In other words, the second terminal of capacitor 64 coupled to transistor 56 may help hold charge. If desired, charge storage structure 64 may be implemented as other charge storage structures (e.g., a storage diode, a storage node, a storage gate, a storage charge structure having a storage region formed in a similar manner as floating diffusion region 48, etc.). If desired, charge storage structure 64 may have storage capacity that is larger than that of floating diffusion region (e.g., that is two times larger, three times larger, five times larger, ten times larger, etc.).

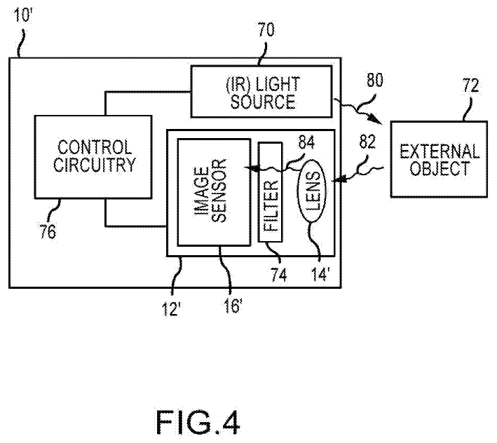

By using pixels such as pixel 22 shown in FIG. 3, an imaging system may be configured to efficiently generate or extract pulsed light information (sometimes referred to as non-color light information) and color light information from image frames. FIG. 4 shows such an imaging system (e.g., imaging system 10′) that is illustrative. If desired, imaging system 10′ may be implemented in a similar manner as imaging system 10 in FIG. 1.

As shown in FIG. 4, imaging system 10′ may include light source 70. Light source 70 may be an infrared (IR) light source that generates IR light (e.g., pulsed IR light) and irradiate portions of an environment using the IR light. As an example, light source 70 may shine IR light on external object 72 (as indicated by ray 80). External object 72 may be a person, a sign, an electronic device, or any other object in the environment of imaging system 10′. To assist in providing information, object 72 may be configured to reflect large amounts of light from light source 70 or have portions or patterns that reflect large amounts of light from light source 70. Light source 70 may be a light-emitting diode or any other light-emitting device operable to generate pulsed light of a wavelength or a band of wavelengths (e.g., wavelengths associated with IR light). Light source 70 may generally generate no colored light (e.g., do not generate RGB or color light, or visible light to the human eye) and be a no-color light source.

If desired, light source 70 may generate coded light (e.g., patterned light), which is used to generate a reflected coded light image for object 72, which can be decoded to determine depth information (e.g., distance of objection from imaging system 10′ and/or depth of object). More specifically, coded light may refer to a light pattern that can be projected onto a 3-D object to generate a corresponding 2-D image based on the reflected pattern from the projection. The distortion in the 2-D representation of the reflected pattern may provide depth data for the 3-D object. If desired, this coded light generated from light source 70 may be pulsed to reduce power. Time coded light may also be used for global shutter capable image sensors. If desired, object 72 may be able to provide color information and non-color (e.g., IR) information, and the non-color information may be deciphered or decoded by illuminating object 72 with light source 70 and subsequently capturing an image based on the illumination.

The (IR or coded) light reflected from the external object may be collected by camera module 12′. In particular, reflected light 82 may pass through an imaging system lens such as lens 14′. Lens 14′ may direct reflected light 82 through filter 74 (sometimes referred to herein as a filter structure or filter layer) to image sensor 16′ as indicated by ray 84. Image sensor 16′ may generate image signals based on pulsed light information from the light reflected off of external object 72 as well as normal color information. The pulsed light information may refer to any information gather based on the irradiation of light source 70 (e.g., based on ray 80, reflected ray 82, and/or directed light 84). As examples, the pulsed light information may convey information about external object 72, identify external object 72, or otherwise convey information about an operational environment of imaging system 10′.

Control circuitry 76 may be coupled to camera module 12′ and light source 70. If desired, control circuitry 76 may be implemented as a portion of control circuitry 24, control circuitry 26, or control circuitry 28 in FIG. 2, may be implemented as a portion of processing circuitry 18 in FIG. 1, may be implemented as separate circuitry from these circuitries, or may be implemented as any combination of circuitries. Control circuitry 76 may provide control signals, clocking or timing signals, data signals, or any other types of signals to light source 70 and/or camera module 12′ to efficiently generate pulsed light and pulsed light information based on the pulsed light.

Image sensor 16′ may be implemented in a similar manner as image sensor 16 in FIG. 2 (e.g., may include pixels 22 in FIG. 3) and may generate image frames that incorporate multi-color data (sometimes referred to herein as color data, RGB data) and any other suitable data such as IR data and coded or pattern data. In some applications, it may be desirable to gather both color data and pulsed light information using an imaging system (e.g., using image sensor 16′) and to do so in time-efficient manner (e.g., using a single integral image frame). System 10′ and image sensor 12′ in FIG. 4 may be configured to gather color information such incorporate multi-color image signals and pulsed light information such as image signals that incorporate light information from light source 70.

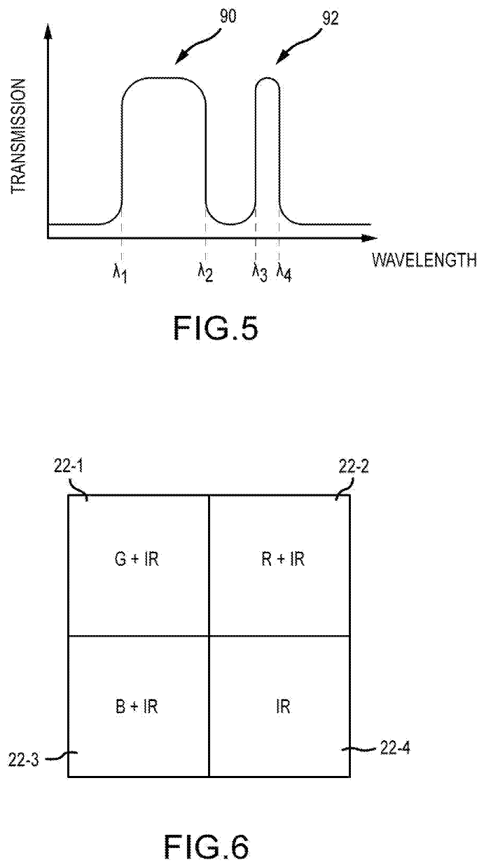

In particular, control circuitry 76 may provide control, timing, and data signals to light source 70 general pulse of light and to image sensor 16′ to generate image frames containing color information and pulsed light information in an efficient manner. As an example, light source 70 may generate pulsed IR light that irradiates an object. Filter 74 may be configured to allow the pass through any reflected IR light (as well as any desirable color light). FIG. 5 shows a graph showing an illustrative transmission characteristic of a filter such as filter 74 in FIG. 4.

As shown in FIG. 5, filter 74 may have a high transmission characteristic between wavelengths λ₁ and λ₂ (band 90) and between wavelengths λ₃ and λ₄ (band 92) and may therefore be a dual-band filter. In some embodiments, band 90 may be associated with wavelengths of visible light such as red, green, blue light, and band 92 may be associated with wavelengths of IR light. In some embodiments, band 90 may be associated with wavelengths of visible light and band 92 may be associated with wavelengths of light generated by light source 70. However, this is merely illustrative. If desired, portions 90 and 92 may be respectively associated with any suitable wavelengths of light. If desired, filter 74 may be a filter layer that passes more than two wavelengths bands of light or that passes a single wavelength band of light (e.g., a single band that includes RGB and IR bands).

Referring back to FIG. 4, image sensor 16′ (similar to image sensor 16 in FIG. 2) may have an array 20 of pixels 22. As mentioned in connection with FIG. 2, array 20 may be overlapped by a filter element array (e.g., a plurality of color filter elements each aligned with a respective pixel 22). Additionally, filter layer 74 may be formed over the filter element array. As an example, filter layer 74 may homogeneously pass color light (e.g., RGB light) and light of light source 70 (e.g., IR light) for pixels 22 across array 20. The filter element array interposed between the homogeneous filter layer 74 and pixel 22 may be formed in two-by-two filter pattern (over a two-by-two pixel array portion) that is repeated across array 20. As an example, a first filter element in the two-by-two pattern may pass red light and IR light. A second filter element in the two-by-two pattern may pass green light and IR light. A third filter element in the two-by-two pattern may pass blue light and IR light. A fourth filter element in the two-by-two pattern may pass IR light (but no RGB color light).

FIG. 6 shows an illustrative portion of pixel array 20 (e.g., an illustrative unit cell) over which filter layer 74 and the two-by-two filter pattern of filter elements is formed. As shown in FIG. 6, the unit cell of pixel array 20 may include pixels 22-1, 22-2, 22-3, and 22-4. Pixel 22-1 (e.g., a photosensitive element in pixel 22-1) may be configured to receive green and IR light. For example, pixel 22-1 may be placed under one or more filter structures that pass only green and IR light to pixel 22-1 (e.g., filter layer 74 and a filter element in the filter element array or a single integral filter element that has the combined properties of these two filter structures). Pixel 22-2 (e.g., a photosensitive element in pixel 22-2) may be configured to receive red and IR light in an analogous manner to pixel 22-1 (e.g., with a filter configuration that passes red and IR light). Pixel 22-3 (e.g., a photosensitive element in pixel 22-3) may be configured to receive blue and IR light in an analogous manner to pixel 22-1 (e.g., with a filter configuration that passes blue and IR light). Pixel 22-4 (e.g., a photosensitive element in pixel 22-4) may be configured to receive IR light. For example, pixel 22-4 may be placed under one or more filter structures that pass only IR light to pixel 22-2 (e.g., filter layer 74 and a filter element in the filter element array that blocks all color light).

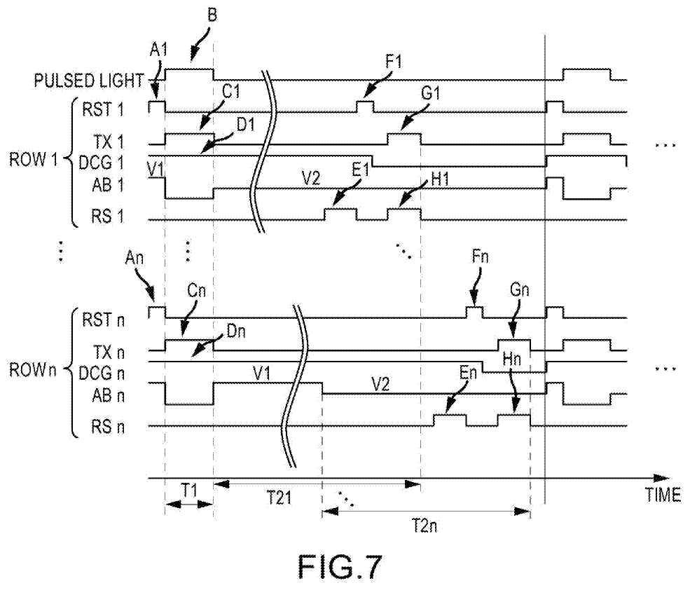

As an example, an illustrative imaging system such as imaging system 10′ in FIG. 4 may have a pixel array organized in a pattern of pixels as shown in FIG. 6 that are repeated across the pixel array. In particular, each pixel in the pixel array may have a configuration of pixel 22 as shown in FIG. 3. FIG. 7 shows a timing diagram for operating such an illustrative imaging system. More specifically, FIG. 7 shows sets of control signals sent to rows of pixels 22 (e.g., a set of control signals shared by row 1 to a row of control signals shared by row n).

As shown in FIG. 7, pixels 22 in array 20 may operate during a global shutter time period T1 and a rolling shutter time period that includes row shutter time periods T21 to T2n (for each of rows 1 to n). Prior to period T1 (in preparation for global shutter operations), control signals RST and AB may be asserted across all pixels 22 in array 20 to reset photodiode 40 and floating diffusion region 48 in each active pixel 22 (across all rows). This is indicated by assertions A1 to An for control signals RST1 to RSTn. Control signals AB1 to ABn may similarly be held at voltage V1 (e.g., a reset level voltage).

During global shutter time period T1, a pulsed light may be generated (see assertion B). For example, control circuitry 76 in FIG. 4 may send a control signal to light source 70 in FIG. 4 that triggers light source 70 to irradiate an object or a scene using light of one or more wavelengths (e.g., using IR light and/or using coded light). At the same time, all pixels 22 in array 20 may simultaneously perform a global shutter operation. In particular, at the beginning of period T1, control signals AB1 to ABn may be deasserted across all pixels 22 to start an image signal integration time period (e.g., by turning off transistors 52 in pixels 22). After a suitable amount of time from the beginning of period T1 or at the beginning of period T1, Control signals TX1 to TXn may be asserted across all pixels 22 to transfer the generated charge in each pixel to the corresponding floating diffusion region 48 of that pixel (e.g., assertions C1 to Cn to turn on transistors 58 in pixels 22). Control signals DCG1 to DCGn may be asserted during and after the generated charge in each pixel is transferred from the corresponding photodiode 40 (e.g., assertions D1 to Dn to turn on transistors 56 in pixels 22). This way, the generated charge may be stored at capacitor 64 in each pixel 22. Global shutter period T1 may end when control signals TX1 to TXn are deasserted (e.g., at the ends of assertions C1 to Cn).

Because light source 70 may illuminate an object or environment and pixels 22 may be sensitive to color light (e.g., RGB light) as well non-color light (e.g., IR light, no-color light based on the pulsed light generated by light source 70), the generated charge in pixels 22 may include color and non-color image signals (generated based on light source 70 and natural light). In other words, pixels 22 in array 20 may generate color and non-color image signals (based on the wavelength of the pulsed light and natural light at the wavelength) during global shutter period T1 and store the generated color and non-color image signals at capacitors 64 across pixels 22 in array 20. If desired, array 20 may include pixels are not sensitive to color light but only to non-color light (e.g., IR pixel 22-4 in FIG. 6). These pixels may generate global shutter non-color (IR) signals based on pulsed light and natural light and store these signals at respective capacitors 64.

After global shutter time period T1, rolling shutter time period T2 may occur. Rolling shutter period T2 may include separate rolling shutter periods for each pixel row such as time periods T21 to T2n for rows 1 to n. Rolling shutter period T21 for row 1 may begin immediately following the end of global shutter period T1. In particular, photodiodes 40 in pixels 22 for row 1 may begin accumulating charge as soon as control signal TX1 is deasserted. This may occur at least because control signal AB1 for row is asserted to a reduced voltage (e.g., partially asserted to voltage V2, an anti-blooming level voltage). While control signal AB1 is partially asserted, transistors 52 in pixels 22 in row 1 may perform anti-blooming operations for photodiode 40. Control signal AB1 may be partially asserted through rolling shutter period T21, or through the entire rolling shutter period T2, if desired.

While pixels 22 in row 1 generate charge based on rolling shutter operations (and/or after the global shutter generated charge is stored at capacitor 64), the global shutter generated charge may be read out from pixels 22 in row 1 (via column lines) by asserting control signal RS1 (e.g., assertion E1). As an example, control signal DCG1 may remain asserted until the end of assertion G1 (e.g., when control signal TX1 is deasserted and the global shutter generated signal is read out).

After assertion G1, control signal RST1 may be asserted (e.g., assertion F1), to reset floating diffusion regions 48 in pixels 22 to a reset voltage level in preparation for reading out the rolling shutter generated signal. If desired, control signal DCG1 remain asserted while assertion F1 occurs to reset the storage node of capacitors 64 in pixels 22 in row 1. Control signal TX1 may be asserted after a suitable integration time period for the rolling shutter operations (e.g., assertion G1) to transfer the rolling shutter generated signals to floating diffusion regions 48 in pixels 22 of row 1. The deassertion of control signal TX1 (e.g., the end of assertion G1) may be indicative of an end of rolling shutter period T21 for row 1. In parallel with assertion G1 and/or after assertion G1, control signal RS1 may be asserted (e.g., assertion H1) to read out the rolling shutter generated charge from pixels 22 in row 1.

Sometime after the beginning of rolling shutter period T21 for row 1, rolling shutter period T22 for row 2 may begin. Sometime after the beginning of rolling shutter period T22 for row 2, rolling shutter period T23 for row 3 may begin. This pattern may continue until rolling period T2n for row n. The same rolling shutter and readout assertions as row 1 may occur for rows 2 to n except shifted by respective time periods. In the example of row n, the time period may span from the beginning of period T21 to the beginning of period T2n. During the respective shifting time periods for each of the rows, control signal AB for the corresponding row may be fully asserted to prevent photodiodes 40 in pixels 22 in that row from accumulating charge. For example, control signal ABn may be fully asserted to voltage V1 during the shifting time period for row n to prevent photodiodes 40 in pixels 22 in row n from accumulating charge.

Because light source 70 may not illuminate an object or environment (e.g., there is no pulsed light assertion) during the rolling shutter period T2, the generated charge in pixels 22 may include color image signals but not image signals obtained based on light from light source 70. However, because pixels 22 may be sensitive to the wavelengths of light generated by light source 70 (e.g., IR wavelengths), pixels 22 may still accumulate natural light of those wavelengths in the environment (e.g., natural IR light). In other words, pixels 22 in array 20 may generate color and non-color image signals (based only on natural light) during rolling shutter period T2 and read out the rolling shutter generated signals after the stored global shutter signals stored at capacitors 64 across pixels 22 are read out. If desired, array 20 may include pixels are not sensitive to color light but only to non-color light (e.g., IR pixel 22-4 in FIG. 6). These pixels may generate rolling shutter generated non-color signals based only on natural light and store the signals at capacitors 64.

The timing diagram of FIG. 7 is merely illustrative. If desired, some assertions may be moved (e.g., shortened and/or expanded) without affecting the two shuttering and readout operations in FIG. 7. As an example, control signals TX1 to TXn may only partially span time period T1. If desired, additional assertions may be added and/or some assertions may be removed. As an example, readout operations may occur for reset level signals (e.g., assertions associated with these reset level readout operations may occur). If desired, lateral optical black pixel compensation may be used to remove dark noise effects. If desired, the operations in these time periods T1, T21, T22, . . . , T2n may repeat to generate additional image signals for subsequent frames.

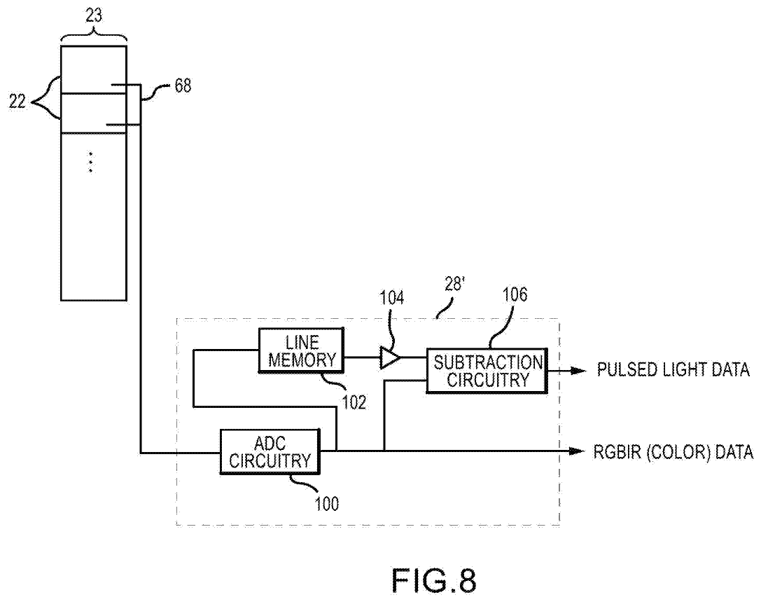

After the global shutter generated signals (e.g., color and non-color signals based on the light source and natural light) and rolling shutter generated signals (e.g., color and non-color signals generated based on natural light) in a given row (e.g., row 1) are read out via column lines, the generated signals are passed to column readout circuitry. FIG. 8 shows illustrative column readout circuitry 28′ (which may be implanted as part of column readout circuitry 28 in FIG. 2) coupled to an illustrative column 23 of pixels 22. If desired, other columns in array 20 may be coupled to readout circuitry 28′ or have their own dedicated readout circuitry similar to readout circuitry 28′.

As shown in FIG. 8, pixel column 23 may be coupled to readout circuitry 28′ via column line 68 (similar to column line 32 in FIG. 2). Readout circuitry 28′ may include analog to digital conversion (ADC) circuitry 100, storage circuitry 102 such as line memory, arithmetic circuitry such as amplifier circuit 104 (or multiplier circuit), and subtraction circuitry 106. If desired, the arithmetic circuitry 106 may be implemented using any suitable circuitry configured to perform linear combinations of inputs (e.g., adders and multiplier). ADC circuitry 100 may be coupled to line memory 102, subtraction circuitry 106 and a first output of readout circuitry 28′. Line memory 102 may be coupled to subtraction circuitry 106 via an intervening amplifier circuit 104. Subtraction circuitry 106 may coupled to a second output of readout circuitry 28′.

In particular, the global shutter generated signals for a given pixel 22 in column 23 may pass through ADC circuitry 100 and be converted to digital data (e.g., global shutter generated data based on light from light source 70 and natural light). The global shutter generated data may be stored at line memory 102. In particular, line memory 102 (sometimes referred to as a row buffer) may be configured to store image data for a single row of image pixels. The stored global shutter generated data may be passed through amplifier 104 that has a fixed or adjustable gain that amplifies or otherwise scales the global shutter generated data. The scaled global shutter generated data may be received at a first input of subtraction circuitry 106.

Subsequent to the readout of the global shutter generated signals, the rolling shutter generated signal for the given pixel 22 in column 23 may pass through ADC circuitry 100 and be converted to digital data (e.g., rolling shutter generated data based on natural light). The rolling shutter generated data may be received at a second input of subtraction circuitry 106.

Subtraction circuitry 106 may generate an output based on subtracting signals received at its second input from its first input. In particular, subtraction circuitry 106 may subtract the rolling shutter generated data from the scaled global shutter generated data. The result may be pulsed light data (e.g., non-color data about an object or environment generated based on pulsed light from a light source, or coded light data for object depth sensing in the case of a light source that generates coded light) and may be provided as an output signal for the second output of readout circuitry 28′. To properly generate the pulsed light data, the gain of amplifier may be fixed or adjustable to account for difference between the global shutter operation and rolling shutter operation such that these different are subtracted out by subtraction circuitry 106 (e.g., the difference may refer to the conversion gain ratio between the global shutter and rolling shutter operations). The rolling shutter generated data (e.g., color and non-color data generated based on natural light or RGBIR, red-green-blue-IR, data) supplied by ADC circuitry 100 may be provided as an additional output signal for the first output of readout circuitry 28′.

The configuration of readout circuitry 28′ is merely illustrative. If desired, other circuitry may be included and/or omitted from the configuration of readout circuitry 28′. As an example, switching circuitry may be coupled along paths between ADC circuitry 100 and line memory 102 and between ADC circuitry and subtraction circuitry 106 to route global shutter data and rolling shutter data in the manner described above. If desired, scaling by amplifier circuit 104 may be provided to the rolling shutter generated data instead of or in addition to the global shutter generated data.

The examples shown in FIGS. 7 and 8 are merely illustrative. If desired, an external frame memory may be used (e.g., instead of line memory 102 in FIG. 8). In this case, the global shutter signals may be generated and read out separately from the rolling shutter frame (e.g., shutter and/or readout may occur in a temporally non-overlapping manner between the global shutter and rolling shutter frames). In the case of FIG. 7, the global shutter and rolling shutter may occur in an integral frame that is used to generate two sets of output data (e.g., pulsed light data and color data).

Various embodiments have been described illustrating systems and methods for generating images having color information as well as pulsed light information.

In particular, an imaging system may include a light source operable to generate a light pulse. The imaging system may include an image sensor having image pixels (arranged in columns and rows) configured to receive a reflected light based on the light pulse, configured to generate a first image signal based on the reflected light during a first shutter operation (such as a global shutter operation), and configured to generate a second image signal during a second shutter operation (such as a rolling shutter operation). The imaging system may include control circuitry configured to control the light source to generate the light pulse during the first shutter operation and not during the second shutter operation. The imaging system may include column readout circuitry configured to generate information associated with the reflected light and to generate color information based on the first and second image signals. The column readout circuitry may be coupled to columns of pixels via column lines. The column readout circuitry may include arithmetic circuits such as multiplier and subtraction circuits. The column readout circuitry may include a memory circuit such as a line memory configured to store image data for a single row of image pixels.

As an example, the light pulse may be a light pulse with wavelengths outside the wavelengths of visible light such as infrared light. In this scenario, the information associated with the reflected light may be infrared signal data, and the readout circuitry may be configured provide the infrared signal data as a first output. If desired, the color information may include red-green-blue (RGB) signal data (as well as infrared data generated based on natural light but not the pulsed light), and the readout circuitry may be configured to provide the RGB signal data as a second output. The readout circuitry may be further configured to generate the information associated with the reflected light based on a subtraction operation using the first image signal and the second image signal (e.g., a subtraction of the second image signal from a scaled version of the first image signal). If desired, the light pulse may be a patterned light pulse, and the information associated with the reflected light may include depth information about an environment or object.

As an example, a given image pixel in the image pixels may include a photosensitive element coupled to a floating diffusion region via a transistor. The given image pixel may include a capacitor coupled to the floating diffusion region via an additional transistor. The capacitor may be configured to store the first (global shutter) image signal while the photosensitive element generates the second (rolling shutter) image signal.

As an example, a filter structure may be formed over the image pixels and may be configured to pass color light and infrared light to the image pixels. The control circuitry may be configured to control the image sensor to perform a global shutter operation for each pulse of (infrared) light from the light source. The control circuitry may be configured to control the image sensor to perform a rolling shutter operation between each set of sequential pulses of (infrared) light from the light source. Processing circuitry may be configured to use image signals generated during the global shutter operation and image signals generated during the rolling shutter operation to extract infrared light data and color light data (useable to generate an RGB color image).

The foregoing is merely illustrative of the principles of this invention and various modifications can be made by those skilled in the art without departing from the scope and spirit of the invention. The foregoing embodiments may be implemented individually or in any combination.

What is claimed is:

1. An imaging system comprising:
a light source operable to generate a light pulse;
an image sensor having image pixels configured to receive a reflected light based on the light pulse, to generate a first image signal based on the reflected light during a first shutter operation, and to generate a second image signal during a second shutter operation;
control circuitry configured to control the light source to generate the light pulse during the first shutter operation and not during the second shutter operation; and
readout circuitry configured to generate information associated with the reflected light and to generate color information based on the first and second image signals.

2. The imaging system defined in claim 1, wherein the light pulse comprises a light pulse with wavelengths outside the wavelengths of visible light.

3. The imaging system defined in claim 1, wherein the light pulse comprises an infrared light pulse, wherein the information associated with the reflected light comprises infrared signal data, and wherein the readout circuitry is configured provide the infrared signal data as a first output.

4. The imaging system defined in claim 3, wherein the color information comprises red-green-blue (RGB) signal data, and wherein the readout circuitry is configured to provide the RGB signal data as a second output.

5. The imaging system defined in claim 4, wherein the second output of the readout circuitry includes infrared data generated based on natural light.

6. The imaging system defined in claim 1, wherein the first shutter operation comprises a global shutter operation.

7. The imaging system defined in claim 6, wherein the second shutter operation comprises a rolling shutter operation.

8. The imaging system defined in claim 7, wherein the readout circuitry is configured to generate the information associated with the reflected light based on a subtraction operation using the first image signal and the second image signal.

9. The imaging system defined in claim 8, wherein the subtraction operation comprises a subtraction of the second image signal from a scaled version of the first image signal.

10. The imaging system defined in claim 1, wherein a given image pixel in the image pixels comprises:
a photosensitive element coupled to a floating diffusion region via a transistor; and
a capacitor coupled to the floating diffusion region via an additional transistor, wherein the capacitor is configured to store the first image signal while the photosensitive element generates the second image signal.

11. The imaging system defined in claim 10, wherein the first image signal comprises an image signal generated during a global shutter operation and wherein the second image signal comprises an image signal generated during a rolling shutter operation.

12. The imaging system defined in claim 1, wherein the light pulse comprises a patterned light pulse and the information associated with the reflected light comprises depth information about an environment.

13. An image sensor comprising:
image pixels arranged in columns and rows; and
column readout circuitry, wherein a given column of image pixels is coupled to the column readout circuitry via a column line and wherein the column readout circuitry comprises:
a memory circuit configured to store global shutter image data; and
arithmetic circuits configured to receive rolling shutter image data and the stored global shutter image data and configured to generate a first output of the column readout circuitry using the rolling shutter image data and the global shutter image data.

14. The image sensor defined in claim 13, wherein the rolling shutter image data are output from the column readout circuitry as a second output of the column readout circuitry.

15. The image sensor defined in claim 14, wherein the rolling shutter image data is useable to generate a red-green-blue (RBG) color image.

16. The image sensor defined in claim 13, wherein the arithmetic circuits comprise a multiplier circuit and a subtraction circuit.

17. The image sensor defined in claim 13, wherein the memory circuit comprises line memory configured to store image data for a single row of image pixels.

18. An imaging system comprising:
an image sensor having an array of pixels;
a filter structure formed over the array of pixels and configured to pass color light and infrared light to the array of pixels;
an infrared light source configured generate pulses of infrared light; and
control circuitry coupled to the infrared light source and the image sensor and configured to control the image sensor to perform a global shutter operation for each pulse in the pulses of infrared light.

19. The imaging system defined in claim 18, wherein the control circuitry is configured to control the image sensor to perform a rolling shutter operation between each set of adjacent pulses in the pulses of infrared light.

20. The imaging system defined in claim 19, further comprising:
processing circuitry configured to use image signals generated during the global shutter operation and image signals generated during the rolling shutter operation to extract infrared light data and color light data.
